(19) United States
(12) Patent Application Publication
(10) Pub. No.: US 2026/0312080 A1
(43) Pub. Date: Oct. 8, 2026

(54) OXYGEN REDUCTION CATALYST AND USE THEREOF

(71) Applicant: TOYOTA JIDOSHA KABUSHIKI KAISHA, Toyota-shi (JP)

(72) Inventor: Keiichi OKUBO, Toyota-shi (JP)

(73) Assignee: TOYOTA JIDOSHA KABUSHIKI KAISHA, Toyota-shi (JP)

(21) Appl. No.: 19/437,768

(22) Filed: Dec. 31, 2025

(30) Foreign Application Priority Data
Apr. 4, 2025 (JP) 2025-062745

(51) Int. Cl. H01M 4/90; C25B 11/095; H01M 4/86

(52) U.S. Cl. CPC H01M 4/9008; C25B 11/095; H01M 4/8657

(57) ABSTRACT

An oxygen reduction catalyst may include a catalyst metal having oxygen reduction reaction activity and a modified layer comprising an organic nitrogen compound having a triazine ring structure represented by the following formula (I) or a cation thereof:

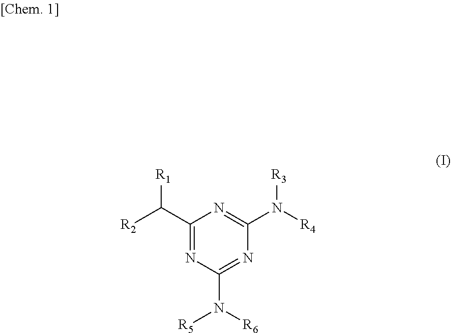

In the formula (I), R₁, R₂, R₃, R₄, R₅, and R₆ each independently represent a hydrogen atom, a group represented by R₇OCH₂—, or a group represented by —X—*, wherein R₇ represents a hydrogen atom or an alkyl group having 3 to 8 carbon atoms, X represents a methylene group (—CH₂—) or a methyleneoxy group (—O—CH₂—), and * represents a bond. However, at least one of R₁, R₂, R₃, R₄, R₅, and R₆ is a group represented by R—OCH₂— (where R_{z} is an alkyl group having 3 to 8 carbon atoms).

### CROSS REFERENCE TO RELATED APPLICATION

This application claims priority to Japanese Patent Application No. 2025-62745 filed on Apr. 4, 2025. The entire content of the priority application is incorporated herein by reference.

### TECHNICAL FIELD

The art disclosed herein relates to an oxygen reduction catalyst and use thereof.

### BACKGROUND ART

Organic nitrogen compounds added to catalyst metals used for fuel cells are known to enhance the activity of oxygen reduction reactions in catalysts, thereby improving the power generation efficiency of fuel cells. Examples of such organic nitrogen compounds include melamine-formaldehyde polymers obtained by polymerizing monomers having aldehyde groups (JP 2024-11754A).

However, it has been found that in fuel cells, interactions between acidic ionomers and basic functional groups of organic nitrogen compounds reduce proton conductivity of the ionomers, and under low-humidity conditions, cause deterioration of ion conductivity and ionomer performance such as durability, thereby degrading cell performance.

The disclosure herein provides a technique that contributes to suppression of the deterioration of ionomer performance under low-humidity conditions by suppressing interactions between ionomers and organic nitrogen compounds such as melamine-formaldehyde polymers, which are added to oxygen reduction reaction catalysts.

The disclosure herein relates to an oxygen reduction catalyst. The oxygen reduction catalyst may comprise a catalyst metal having oxygen reduction reaction activity; and a modified layer comprising an organic nitrogen compound having a triazine ring structure represented by the following formula (I) or a cation thereof.

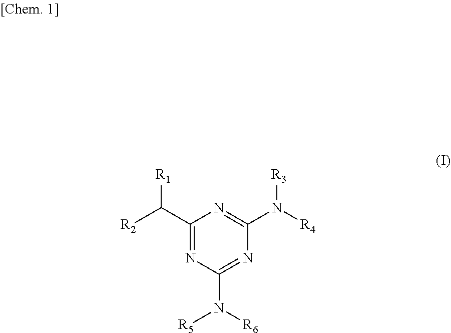

In the formula (I), R₁, R₂, R₃, R₄, R₅, and R₆ each independently represent a hydrogen atom, a group represented by R₇OCH₂—, or a group represented by —X—*, wherein R₇ represents a hydrogen atom or an alkyl group having 3 to 8 carbon atoms, X represents a methylene group (—CH₂—) or a methyleneoxy group (—O—CH₂—), and * represents a bond. However, at least one of R₁, R₂, R₃, R₄, R₅, and R₆ is a group represented by R—OCH₂— (where R₇ is an alkyl group having 3 to 8 carbon atoms).

According to this oxygen reduction catalyst, the modified layer includes the organic nitrogen compound having the triazine ring structure. Since the triazine ring structure has a bulky functional group (alkyl group having 3 to 8 carbon atoms), physical contact between the organic nitrogen compound and an acidic ionomer can be suppressed, thereby suppressing interactions between them. This suppresses deterioration of ionomer performance under low-humidity conditions. As a result, deterioration of cell performance is also suppressed.

### DETAILED DESCRIPTION

The oxygen reduction catalyst disclosed herein may further include the aspects below. In an aspect of the oxygen reduction catalyst, the organic nitrogen compound may comprise a melamine-formaldehyde polymer. The inclusion of the melamine-formaldehyde polymer facilitates tight adhesion and integration of the modified layer to the catalyst metal.

In another aspect of the oxygen reduction catalyst, R₇ in the formula (I) may be a branched alkyl group. This effectively confers steric bulkiness, thereby suppressing physical contact between the organic nitrogen compound and an ionomer.

In another aspect of the oxygen reduction catalyst, R₇ in the formula (I) may be a branched alkyl group, and a ratio of a molar amount of R₇ to a total molar amount of triazine rings of the organic nitrogen compound may be 0.28 or more. This more effectively suppresses physical contact between the organic nitrogen compound and an ionomer, thereby suppressing interactions between them.

In another aspect of the oxygen reduction catalyst, R₇ in the formula (I) may be one or more selected from the group consisting of a isopropyl group, a sec-butyl group, a isobutyl group, and a tert-butyl group. These functional groups provide both bulkiness and ease of introducing the functional groups.

The disclosure herein is also directed to a cathode for a fuel cell comprising the above-described oxygen reduction catalyst and a fuel cell comprising this cathode.

The disclosure herein is also directed to an anode for a water electrolysis system comprising the above-described oxygen reduction catalyst and a water electrolysis system comprising this anode.

Representative, non-limiting examples of the present disclosure will now be described in further detail with reference to the attached drawings. This detailed description is merely intended to teach a person of skill in the art further details for practicing preferred aspects of the present teachings and is not intended to limit the scope of the disclosure. Furthermore, each of the additional features and teachings disclosed below may be utilized separately or in conjunction with other features and teachings to provide improved oxygen reduction catalysts and uses thereof.

Moreover, combinations of features and steps disclosed in the following detailed description may not be necessary to practice the disclosure in the broadest sense, and are instead taught merely to particularly describe representative examples of the disclosure. Furthermore, various features of the above-described and below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

Hereinafter, various embodiments of the oxygen reduction catalyst (which may be simply referred to as “catalyst”) disclosed herein are described in detail.

The oxygen reduction catalyst disclosed herein may be used for fuel cells or for metal-air batteries. The catalyst disclosed herein may be used for a cathode of a fuel cell, for an anode of a fuel cell, or for an air electrode of a metal-air battery. Furthermore, the catalyst disclosed herein may be used for an anode for water electrolysis, which is the reverse reaction in fuel cells, for a cathode for water electrolysis, for an anode for CO₂ reduction, or for a cathode for CO₂ reduction.

The oxygen reduction catalyst disclosed herein may, for example, be in the form of a catalyst ink or in a layered form. A binder (which will be described below) may be used as needed.

### (Oxygen Reduction Catalyst)

The oxygen reduction catalyst disclosed herein comprises a catalyst metal and a modified layer comprising an organic nitrogen compound having a triazine ring structure represented by formula (I) or a cation thereof. Hereinbelow, these elements are described.

### (Catalyst Metal)

The catalyst metal contained in the catalyst is not particularly limited as long as it has oxygen reduction activity. Examples of the catalyst metal include metals such as platinum, ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and the catalyst metal may be a combination of two or more of these metals. Additionally, the metals may be oxides, nitrides, sulfides, or phosphides.

The catalyst metal may preferably be one or more selected from platinum, platinum alloys, and platinum-containing complexes. Examples of the metals other than platinum contained in the platinum alloys and the platinum-containing complexes include ruthenium, iridium, rhodium, palladium, osmium, tungsten, lead, iron, chromium, cobalt, nickel, manganese, vanadium, molybdenum, gallium, aluminum, lanthanum, cerium, praseodymium, neodymium, samarium, gadolinium, and yttrium, and the metals may comprise two or more of these metals. The atomic percentages of the metals other than platinum in the platinum alloys are not particularly limited and may be 0.11 to 50 at %.

The catalyst metal is typically in the form of metal particles. The average particle size (particle diameter) is not specifically limited and may be, for example, 1 nm or more and 100 nm or less.

The catalyst metal may be supported on a carrier. Examples of the carrier include carbon and oxides. The carrier may be, for example, conductive carbon, an oxide, or a mixture containing at least two of these. Examples of the carbon include carbon black (acetylene black, Ketjen black, channel black, roller black, disk black, oil furnace black, gas furnace black, lamp black, thermal black, and VULCAN (registered trademark) carbon, etc.), activated carbon, black lead, glassy carbon, graphite, graphene, carbon fibers, carbon nanotubes, carbon nitrides, carbon sulfides, carbon phosphides, and mixtures containing at least two of these. Examples of the oxide include titanium oxides, niobium oxides, tin oxides, tungsten oxides, molybdenum oxides, and mixtures containing at least two of these.

The carrier may be either primary particles or secondary particles. The average particle size of the primary particles is not particularly limited and may be, for example, 5 nm or more and 500 nm or less.

### (Modifying Layer)

The modified layer is provided on the surface of the catalyst metal to accelerate the oxygen reduction activity of the catalyst metal. The modified layer contains an organic nitrogen compound or a cation thereof. The term “cation” herein includes a cation resulting from ionization of a basic functional group of the organic nitrogen compound, or a cation forming a salt with an organic or inorganic acid.

### (Organic Nitrogen Compound(s)

The organic nitrogen compound may be any kind as long as it has activity of promoting oxygen reduction activity by the catalyst metal. The organic nitrogen compound comprises a triazine ring structure represented by the formula (I) below. The organic nitrogen compound may be a non-polymeric monomer, a polymer, or one or a combination of cations (salts) thereof.

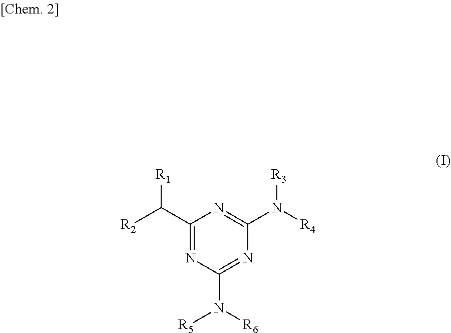

In the formula (I), R₁, R₂, R₃, R₄, R₅, and R₆ each independently represent a hydrogen atom, a group represented by R₇OCH₂—, or a group represented by —X—*, where R₇ represents a hydrogen atom or an alkyl group having 3 to 8 carbon atoms, X represents a methylene group (—CH₂—) or a methyleneoxy group (—O—CH₂—), and * represents a bonding site. However, at least one of R₁, R₂, R₃, R₄, R₅, and R₆ is a group represented by R₇OCH₂— (where R₇ is an alkyl group having 3 to 8 carbon atoms).

The bonding site is a bonding site to the triazine structure represented by the formula (I).

The content of the group represented by R₇OCH₂—(R₇: alkyl group having 3 to 8 carbon atoms) in the organic nitrogen compound is not particularly limited as long as it is contained to an extent sufficient to suppress physical contact with ionomers. For example, it may be preferable that a ratio of the molar amount of the group represented by R₇OCH₂— to the total molar amount of triazine rings of the organic nitrogen compound is 0.20 or more. This ensures sufficient steric bulkiness around the triazine rings and effectively suppresses physical contact between the organic nitrogen compound and ionomers. For example, the ratio may be 0.28 or more, 0.30 or more, 0.32 or more, 0.34 or more, 0.35 or more, 0.50 or more, 0.60 or more, 0.70 or more, 0.80 or more, 0.90 or more, 1.0 or more, 1.1 or more, 1.2 or more, 1.3 or more, 1.4 or more, 1.5 or more, 1.6 or more, 1.8 or more, 2.0 or more, 2.1 or more, or 2.5 or more. Also, the ratio may be 4.0 or less, 3.0 or less, 2.5 or less, 2.2 or less, 2.1 or less, 2.0 or less, 1.9 or less, 1.8 or less, 1.7 or less, 1.6 or less, 1.5 or less, 1.4 or less, 1.3 or less, 1.2 or less, 1.1 or less, 1.0 or less, 0.9 or less, 0.8 or less, 0.7 or less, 0.6 or less, 0.5 or less, 0.4 or less, or 0.3 or less. The content range of the group represented by R₇OCH₂— may be set by combining the above lower and upper limits as desired. The range may be, for example, 0.28 or more and 2.2 or less, 0.28 or more and 2.1 or less, 0.28 or more and 2.0 or less, or 0.30 or more and 2.0 or less.

The alkyl group having 3 to 8 carbon atoms as R₇ may be selected independently as appropriate. The alkyl group may be a linear alkyl group or a branched alkyl group, but branched alkyl group is preferred. Since branched alkyl groups are sterically bulky, they can suppress physical contact with surrounding ionomers. Alkyl groups having 3 to 8 carbon atoms may be used as the branched alkyl group. In particular, branched alkyl groups having 3 to 6 carbon atoms, 3 to 5 carbon atoms, or 3 to 4 carbon atoms may be preferable. For example, it is preferable that the alkyl group having 3 to 8 carbon atoms (i.e., R₇) is one or more selected from the group consisting of a isopropyl group, a sec-butyl group, a isobutyl group, and a tert-butyl group. These functional groups provide steric bulkiness and ease of introducing the functional groups. The branched alkyl group may be an isopropyl group or an isobutyl group.

When the organic nitrogen compound is a polymer, it may comprise, in addition to the triazine structure described above, structural units derived from other monomers. For example, the polymer may include a structural unit derived from thioisocyanuric acid. Examples of thioisocyanuric acid compound include thioisocyanuric acid and derivatives thereof. Examples of cyanuric acid compound include cyanuric acid and derivatives thereof.

The organic nitrogen compound may be obtained by known methods or commercially available. When the organic nitrogen compound is a polymer, its polymerization condition may be a condition for polymerizing melamine and formaldehyde or a condition for alcohol modification. The degree of polymerization and molecular weight of the polymer are not particularly limited. Inclusion of the polymer in the modified layer facilitates its adhesion to the catalyst metal and improves adhesion stability. The polymer may have a degree of polymerization in the range of 1 to 10,000. The X in the bonding site may vary depending on polymerization condition, etc.

The organic nitrogen compound is not particularly limited, but an example thereof is a polymer having the following structural units.

When the organic nitrogen compound is a polymer, an example thereof is the following melamine-formaldehyde polymer. At least one R′ represents an alkyl group having 3 to 8 carbon atoms, such as a branched alkyl group having 3 to 8 carbon atoms, a branched alkyl group having 3 to 5 carbon atoms, or a branched alkyl group having 3 to 4 carbon atoms.

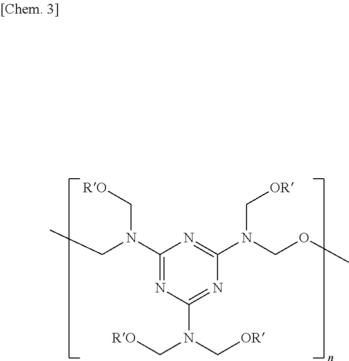

The content of the organic nitrogen compound in the catalyst is not particularly limited. For example, the total mass of the organic nitrogen compound relative to the mass of a carrier carrying the catalyst metal may be 1.0 mass % or more and 15 mass % or less.

The mass of the organic nitrogen compound is measured by extracting the organic nitrogen compound from the catalyst and measuring it by chromatography such as HPLC or GC. For identification of the compound, an appropriate method such as mass spectrometry, NMR, IR, and UV may be used. Further, the mass of the carrier can be measured as follows. Organic compounds such as the organic nitrogen compound and a binder are removed from the catalyst by solvent separation to obtain the remaining catalyst-metal-supported carrier. Then, catalyst-metal-supported carrier is calcined to remove the carrier and the mass of the carrier is calculated from the mass of the residue (the catalyst metal).

### (Binder)

The catalyst can further include a binder. The binder is a polymer electrolyte containing an ion exchange group such as an acidic functional group or a basic functional group. The polymer electrolyte may be referred to as an electrolyte or ionomer. Examples of the acidic functional group include sulfonic acids and phosphoric acids. Examples of the basic functional group include quaternary ammonium cations. The binder may be a perfluorocarbon sulfonic acid polymer, an anion exchange polymer, or a polymer primarily composed of polyether ether ketone or polybenzimidazole.

The content of the binder in the catalyst is not particularly limited as long as it can form the modified layer on the catalyst metal. For example, the ratio of the binder's mass to the carrier's mass can be 70 mass % or more and 115 mass % or less. The mass of the carrier has already been described. The mass of the binder is measured by extracting the binder from the catalyst. For identification of the binder, an appropriate method such as mass spectrometry, NMR, IR, or UV can be used.

As described above, the catalyst can be in the form of a catalyst ink, and after application of the catalyst ink, it can be in the form of a catalyst layer. Hereinafter, formation of a catalyst ink and a catalyst layer is described.

### (Preparation of Catalyst Ink)

First, predetermined amounts of a catalyst metal carrier (carrier supporting a catalyst metal), organic nitrogen compound(s), a radical quencher, a binder, and a solvent are added to a container, and they are stirred by a stirrer to prepare a catalyst ink. The type of solvent is not particularly limited and any liquid can be used. Examples of the solvent include alcohols and mixtures of at least one alcohol and water. Examples of the alcohols include methanol, diacetone alcohol, ethanol, 1-propanol, 2-propanol, tert-butyl alcohol, ethylene glycol, and propylene glycol.

The stirrer is not particularly limited and any known stirrer can be used. Examples of the stirrer include ultrasonic homogenizers, jet mills, ball mills such as bead mills, high-shear mixers, and philmix. Stirring conditions such as stirring speed, stirring time, and rotation speed are not particularly limited and may be set as appropriate.

After stirring, vacuum degassing is performed, and the container is left to stand for one day. The standing time is not particularly limited and may be set as desired. Alternatively, the container may not be left to stand. Furthermore, the vacuum degassing may be performed again.

### (Formation of Catalyst Layer)

The prepared catalyst ink is applied onto a predetermined substrate, and the solvent is removed after the application. For example, the catalyst ink is applied onto the substrate, and the applied catalyst ink is heated to dry and remove the solvent.

The substrate is not particularly limited and examples of the substrate include polytetrafluoroethylene (PTFE), electrolyte membranes having ion exchange groups, gas diffusion layers (GDLs) composed of carbon fibers and/or metal fibers, and gas diffusion layers composed of carbon fibers and/or metal fibers having microporous layers (MPLs).

The method of applying the catalyst ink onto the substrate may be any method as long as it can uniformly apply the catalyst ink onto the substrate, and the method may be die coating, spin coating, screen printing, doctor blade coating, squeegee coating, spray coating, or applicator coating. The heating rate and heating time may be appropriately set depending on the type of solvent. Additionally, the removal rate may be increased by degassing simultaneously with heating. The layer thickness may be 5 to 30 μm, and the catalyst ink may be applied such that the platinum content satisfies 0.1 to 0.6 mg·cm⁻².

### (Catalyst Layer)

According to the disclosure herein, an oxygen reduction catalyst layer or an oxygen generation catalyst layer containing the above-described catalyst is provided. Since the oxygen reduction reaction of the catalyst metal is reversible, a fuel cell comprising this catalyst layer as a cathode (oxygen reduction catalyst layer) is also provided. The fuel cell may be, for example, a PEFC. In such a fuel cell, a decrease in the power generation efficiency of the fuel cell due to radical generation is avoided or suppressed.

Furthermore, a water electrolysis device comprising a catalyst layer containing the above-described catalyst as an anode (oxygen evolution reaction catalyst layer) is also provided. In such a water electrolysis device, a decrease in the water generation efficiency of the water electrolysis device due to radical generation is avoided or suppressed.

### EXAMPLES

Hereinafter, examples of the disclosure herein are described. These examples are provided to illustrate the disclosure herein and are not intended to limit the scope of the disclosure.

### Example 1

Predetermined amounts of a catalyst-metal-particle-supported carrier in which platinum particles (particle diameter: 3 to 4 nm) as the catalyst metal are supported on a carrier (acetylene black), an organic nitrogen compound (melamine-formaldehyde polymer) having a triazine ring structure, a perfluorocarbon sulfonic acid as a binder, and a water-alcohol mixture as a solvent, which are shown in Table 1 below, were put into a container. Table 1 shows types of alkyl group of R₇ in the formula (I) and ratios of molar amount of alkyl groups per mole of triazine ring.

These materials were mixed and stirred using a stirrer (homogenizer, philmix) to prepare catalyst inks of Examples 1 to 5 containing the oxygen reduction catalyst.

Catalyst inks of Comparative Examples 1 to 4 were prepared in the same manner as in Example 1 except that: the inks do not contain the organic nitrogen compound and contain a triazine (monomer) that does not contain alkoxy groups, a melamine-formaldehyde polymer including a triazine ring structure having a methyl group as an alkyl group of alkoxy group, and a melamine-formaldehyde polymer including a triazine ring structure that contains a isobutyl group as an alkyl group of alkoxy group in specified amount.

The melamine-formaldehyde polymers and the other components used in the Examples and Comparative Examples were obtained from Tokyo Chemical Industry Co., Ltd. and Sigma-Aldrich Co. LLC.

After degassed appropriately, each catalyst ink was applied onto a substrate and the catalyst ions were heated after the application to remove the solvent, thereby forming a catalyst layer.

Then, the formed catalyst layers were used as cathode catalyst layers, perfluorocarbon sulfonic acid polymer (Chemours Nafion NR211, EW: 1100) was used as electrolyte membranes, and platinum-supported carbon catalyst (Tanaka Precious Metal Technologies Co., Ltd., TEC10E50E) was used as anode catalyst layers. Each electrolyte membrane was sandwiched between a cathode catalyst layer and an anode catalyst layer. Under the heat (130° C.) and pressure (3 MPa), the cathode catalyst layer, the electrolyte membrane, and the anode catalyst layer were thermally bonded. Gas diffusion layers (SGL Corporation, 22BB) made of carbon fibers were placed on the outer sides of the cathode catalyst layer and the anode catalyst layer to make a membrane electrode assembly (MEA) (electrode portion: 1 cm×1 cm).

TABLE 1

| | | R⁷ in the triazine ring structure | | | | Cell | Cell |
|---|---|---|---|---|---|---|---|
| | | | Number of | | Molar ratio | voltage at | voltage at |
| | | | Carbon | | relative to the | 30% RH, | 80% RH, |
| Sample Type | | R⁷ | Atoms | Branched | triazine ring | 0.2 A/cm² | 0.2 A/cm² |
| Examples | 1 | Isobutyl* | 4 | Present | 0.28 | 2 | 10 |
| | 2 | Isopropy* | 3 | Present | 0.35 | 2 | 14 |
| | 3 | Isobutyl* | 4 | Present | 2.13 | 4 | 10 |
| | 4 | n-Butyl* | 4 | None | 1.04 | 1 | 10 |
| | 5 | n-Butyl* | 4 | None | 1.36 | 1 | 10 |
| Comparative | 1 | Unmodified | — | None | 0 | 0 | 0 |
| Example | 2 | Unmodified | 0 | None | 0 | −13 | 13 |
| | | monomer | | | | | |
| | 3 | Methyl* | 1 | None | 0.6 | −13 | 13 |
| | 4 | Isobutyl* | 4 | Present | 0.11 | −8 | 11 |

*Melamine-formaldehyde polymer

The fabricated MEAs were used as single cells to measure current-voltage characteristics under a low-humidity condition (30% RH) and a high-humidity condition (80% RH). The measurement conditions were as follows: sweep rate: 20 mA/s (anode sweep), cell temperature: 80° C., pressure: 150 kPa_ABS, cathode gas: air, cathode gas flow rate: 2.0 L/min. Current-voltage characteristics may be measured under any condition. The results are shown in Table 1.

As shown in Table 1, it has been found that the inclusion of alkoxy group in the triazine ring structure suppresses a reduction in cell voltage under the low-humidity condition. Moreover, it has been also found that the inclusion of alkoxy group of branched alkyl group rather than linear alkyl group is more effective in suppressing a reduction in cell voltage under the low-humidity condition.

Further, it has been found that it is preferable the amount of alkoxy group per triazine ring is a certain amount or more. For example, this ratio is 0.28 or more, and 2.0 or less

What is claimed is:

1. An oxygen reduction catalyst comprising:
a catalyst metal having oxygen reduction reaction activity; and
a modified layer comprising an organic nitrogen compound having a triazine ring structure represented by the following formula (I) or a cation thereof: 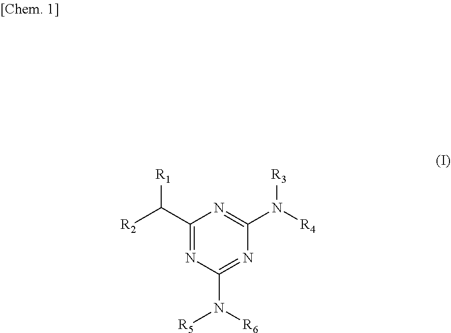
In the formula (I), R₁, R₂, R₃, R₄, R₅, and R₆ each independently represent a hydrogen atom, a group represented by R₇OCH₂—, or a group represented by —X—*, wherein R₇ represents a hydrogen atom or an alkyl group having 3 to 8 carbon atoms, X represents a methylene group (—CH₂—) or a methyleneoxy group (—O—CH₂—), and * represents a bonding site. However, at least one of R₁, R₂, R₃, R₄, R₅, and R₆ is a group represented by R—OCH₂— (where R₇ is an alkyl group having 3 to 8 carbon atoms).

2. The oxygen reduction catalyst according to claim 1, wherein the organic nitrogen compound comprises a melamine-formaldehyde polymer.

3. The oxygen reduction catalyst according to claim 1, wherein R₇ in the formula (I) is a branched alkyl group.

4. The oxygen reduction catalyst according to claim 1, wherein
R₇ in the formula (I) is a branched alkyl group, and
a ratio of a molar amount of R₇ to a total molar amount of triazine rings of the organic nitrogen compound is 0.28 or more.

5. The oxygen reduction catalyst according to claim 1, wherein R₇ in the formula (I) is one or more selected from the group consisting of an isopropyl group, a sec-butyl group, an isobutyl group, and a tert-butyl group.

6. A cathode for a fuel cell comprising the oxygen reduction catalyst according to claim 1.

7. A fuel cell comprising the cathode according to claim 6.

8. An anode for a water electrolysis system comprising the oxygen reduction catalyst according to claim 1.

9. A water electrolysis system comprising the anode according to claim 8.
